(19) United States
(12) Patent Application Publication
(10) Pub. No.: US 2008/0006701 A1
(43) Pub. Date: Jan. 10, 2008

(54) MEDIA TYPE SUPPORTING METHOD AND SYSTEM

(75) Inventors: HENRY CHEN, SHANGHAI (CN); FAN CHEN, SHANGHAI (CN); JESSICA CHEN, SHANGHAI (CN); SLUG ZHANG, SHANGHAI (CN)

Correspondence Address: J C PATENTS, INC., 4 VENTURE, SUITE 250, IRVINE, CA, 92618, US

(73) Assignee: SINO WEALTH ELECTRONIC (SHANGHAI) LTD., SHANG-HAI (CN)

(21) Appl. No.: 11/470,503

(22) Filed: Sep. 6, 2006

(30) Foreign Application Priority Data
Jul. 7, 2006 (CN) 200610028716.8

(51) Int. Cl. G06K 7/00

(52) U.S. Cl. 235/486

(57) ABSTRACT

A method and a system for supporting media types adapted for a portable media playback apparatus is provided. The method includes: providing a media type transfer program in the portable media playback apparatus; executing the media type transfer program when the portable media playback apparatus is linked to a media provider; transferring the type of the specific medium to a type supported by the portable apparatus through the media type transfer program when the media provider receives an instruction which indicates the media provider to store a specific medium into the portable media playback apparatus, and the portable apparatus does not support the type of the specific medium; and storing the transferred specific medium into the portable media playback apparatus.

### BACKGROUND OF THE INVENTION

1. Field of the Invention

The present invention relates to a portable media playback system. More particularly, the present invention relates to a media type supporting method and system.

2. Description of Related Art

Along with the progress in science and technology, various audio-visual multimedia playback apparatuses including portable audio-visual multimedia playback apparatuses such as CD-ROM walkman, DVD-ROM walkman and MP3 (MPEG Layer 3) player are becoming more and more popular in our daily life as their performances are continuously being improved and their prices continuously being reduced.

Being limited by hardware, ordinary portable media playback apparatuses such as multimedia playback pocket players in the form of a flash memory can only support a few fixed types. For example, the media type supported by the MP3 pocket player on the market generally is not over two types (MP3 and WMA).

With the rapid changes in science and technology, new multimedia types being developed as well, which further compresses the music and image and improves the quality of voice and image. However, as new multimedia types appear continuously, the old portable media playback apparatus adopted can hardly play the new multimedia types. Moreover, if the products of the portable media playback apparatus are used to support various multimedia types, accordingly, more hardware resources are needed and the cost on research & development is greatly increased. Therefore, the portable media playback apparatus that can simultaneously support more than three multimedia types is rarely seen in the market. Further, currently the music types in a personal computer terminal have exceeded 10, wherein the common music types have reached 6 or 7. Thus, as the new media types are increasing continuously, the disadvantages of the above conventional art are becoming more and more obvious.

### SUMMARY OF THE INVENTION

An objective of the present invention is to provide a media type supporting method for utilizing the architecture of the existing portable media playback apparatus to achieve the effect of supporting different media types without increasing the hardware resources of the portable media playback apparatus.

Another objective of the present invention is to provide a media type supporting system for making the portable media playback apparatus support various media types.

The present invention provides a media type supporting method adapted for a portable media playback apparatus. The method comprises: providing a media type transfer program in the portable media playback apparatus; executing the media type transfer program when the portable media playback apparatus is linked to a media provider; transferring the type of the specific medium to the type supported by the portable apparatus through the media type transfer program when the media provider receives an instruction which indicates the media provider to store a specific medium into the portable media playback apparatus, and the portable apparatus does not support the type of the specific medium; and storing the transferred specific medium into the portable media playback apparatus.

According to the media type supporting method described in the preferred embodiment of the present invention, the above step of executing the media type transfer program when the portable media playback apparatus is linked to the media provider comprises: loading the media type transfer program into the media provider when the portable media playback apparatus is linked to the media provider through an interface bus; and residing the media type transfer program in the media provider. In an embodiment, the interface bus is a universal serial bus (USB).

According to a preferred embodiment of the present invention, the step of transferring the type of the specific medium to the type supported by the portable apparatus through the media type transfer program when the media provider receives an instruction which indicates the media provider to store a specific medium to the portable media playback apparatus and the portable apparatus does not support the type of the specific medium comprises: checking whether the specific medium conforms to the type supported by the portable media playback apparatus when the user issues an instruction to the media provider to replicate the specific medium to the portable media playback apparatus; and transferring the specific medium type through the media type transfer program when the specific medium type is not the type supported by the portable media playback apparatus. In an embodiment, the media provider is a computer, and the media type transfer program transfers type in the operating system of the computer.

According to a preferred embodiment of the present invention, the above portable media playback apparatus is a portable media playback apparatus for various storage media such as ROM memory, NAND or NOR flash memory, flash memory card (the flash memory card usually seen in the market such as SD, MMC, SMC, EF, MS) or mini hard disc.

The present invention provides a media type supporting system, which comprises: a portable media playback apparatus and a media provider. The portable media playback apparatus comprises a media type decoding engine and a music type transfer program. When the portable media playback apparatus is linked to the media provider, the media type transfer program is executed. When the media provider receives an instruction which indicates the media provider to store a specific medium into the portable media playback apparatus, and the portable apparatus does not support the type of the specific medium, the type of the specific medium is transferred to the type supported by the portable apparatus.

According to a preferred embodiment of the present invention, the step of executing the media type transfer program when the portable media playback apparatus is linked to the media provider comprises: loading the media type transfer program into the media provider when the portable media playback apparatus is linked to the media provider through an interface bus; and residing the media type transfer program in the media provider. In an embodiment, the interface bus is a USB.

According to a preferred embodiment of the present invention, the step of transferring the type of the specific medium to the type supported by the portable apparatus through the media type transfer program when the media provider receives an instruction which indicates the media provider to store a specific medium into the portable media playback apparatus and the portable apparatus does not support the type of the specific medium comprises: checking whether the specific medium conforms to the type supported by the portable media playback apparatus when the user issues an instruction to the media provider to replicate the specific medium to the portable media playback apparatus; and transferring the specific medium type through the media type transfer program when the specific medium type is not the type supported by the portable media playback apparatus. In an embodiment, the media provider is a computer, and the media type transfer program transfers type in the operating system of the computer.

According to a preferred embodiment of the present invention, the above portable media playback apparatus is a flash memory portable media playback apparatus or a mini disc portable media playback apparatus.

In an aspect of the present invention, a media type transfer program is built in the portable media playback apparatus. When the portable media playback apparatus is linked to the media provider, the media type transfer program is automatically executed and resides in the above media provider. In another aspect of the present invention, if a media file is to be replicated from the media provider to the portable media playback apparatus, the media file to be replicated is transferred to the type supported by the portable media playback apparatus through the media type transfer program. Therefore, the method and system of the present invention can utilize the architecture of the existing portable media playback apparatus to achieve the effect of supporting various media types without increasing the hardware resources of the portable media playback apparatus.

In order to make the aforementioned and other objectives, features and advantages of the present invention comprehensible, preferred embodiments accompanied with figures are described in detail below.

### BRIEF DESCRIPTION OF THE DRAWINGS

FIG. 1 is a flow chart of a media type supporting method according to an embodiment of the present invention.

FIG. 2 is a flow chart of a media type supporting system according to an embodiment of the present invention.

### DESCRIPTION OF EMBODIMENTS

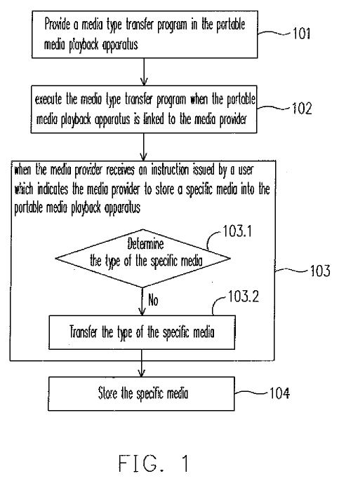

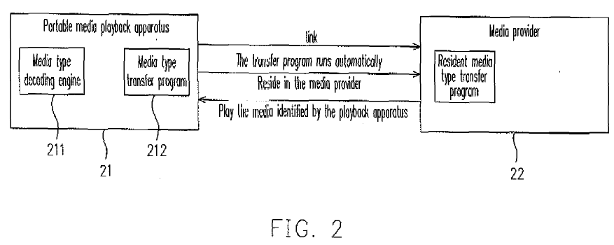

FIG. 1 is a flow chart of a media type supporting method according to an embodiment of the present invention. FIG. 2 is a flow chart of a media type supporting system according to an embodiment of the present invention. Referring to FIGS. 1 and 2 at the same time, the system in FIG. 2 comprises a portable media playback apparatus 21 and a media provider 22, wherein the portable media playback apparatus 21 comprises a media decoding engine 211 and a media type transfer program 212. The present invention will be illustrated below with reference to the flows in FIGS. 1 and 2.

First of all, a media type transfer program is provided in the portable media playback apparatus (Step 101). Then, when the portable media playback apparatus is linked to the media provider, the media type transfer program is executed (Step 102). For illustration purpose, here the portable media playback apparatus is an MP3 pocket player and the media provider is a personal computer with windows operating system as an example. When the MP3 pocket player is linked to the computer through USB, the media type transfer program built in the MP3 pocket player will be automatically executed immediately, wherein the executing manner is, for example, AutoRun after an optical disc is put into the optical disc drive. The media type transfer program resides in the windows operating system.

Next, when the media provider (for example, the above personal computer) receives an instruction issued by a user which indicates the media provider to store a specific medium into the portable media playback apparatus (MP3 pocket player) (Step 103), assume that the MP3 pocket player only supports music of MP3 type, and the type of the specific medium is WMA type. Then, the media type transfer program residing in the media provider (personal computer) first determines whether or not the type of the specific medium is MP3 type supported by the MP3 pocket player (Step 103.1), and if so, transfers the type of the specific medium to the MP3 type supported by the portable media playback apparatus through the media type transfer program residing in the windows operating system (Step 103.2). Finally, the transferred specific medium is stored into the portable media playback apparatus (Step 104).

The above Step 103.2 of transferring the type of the media file and Step 104 of replicating the medium to the portable media playback apparatus can, for example, transfer the type in the operating system. Furthermore, technicians in the art should understand that the so-called link is not limited to the link through USB. For example, assume the media provider is a personal computer. If the above personal computer is provided with a blue tooth transceiver or wireless network service, and the portable media playback apparatus also supports the transmission and receiving of the blue tooth or the city wireless network, the present method can easily achieve the same purpose.

Another example, wherein the media provider is a network server. The portable media playback apparatus is linked to this network server through a wired or wireless network and the media type transfer program is executed in the network server, so as to achieve the above actions. Thus, the present invention is not limited to the present embodiment.

In view of the above, in an aspect of the present invention, a media type transfer program is built in the portable media playback apparatus. When the portable media playback apparatus is linked to the media provider, the media type transfer program is executed automatically and resides in the above media provider. In another aspect of the present invention, if a media file is to be replicated from the media provider to the portable media playback apparatus, the media file to be replicated is transferred to the type supported by the portable media playback apparatus through the media type transfer program. Therefore, the method and system of the present invention can utilize the architecture of the existing portable media playback apparatus to achieve the objective of supporting various media types without increasing the hardware resources of the portable media playback apparatus.

Though the present invention has been disclosed above by the preferred embodiments, they are not intended to limit the present invention. Those skilled in the art can make some modifications and variations without departing from the spirit and scope of the present invention. Therefore, the protecting range of the present invention falls in the appended claims.

What is claimed is:

1. A media type supporting method, adapted for a portable media playback apparatus, comprising:
providing a media type transfer program in the portable media playback apparatus;
executing the media type transfer program when the portable media playback apparatus is linked to a media provider;
transferring the type of the specific medium to the type supported by the portable apparatus through the media type transfer program when the media provider receives an instruction which indicates the media provider to store a specific medium into the portable media playback apparatus, and the portable apparatus does not support the type of the specific medium; and
storing the transferred specific medium into the portable media playback apparatus.

2. The media type supporting method as claimed in claim 1, wherein the step of executing the media type transfer program when the portable media playback apparatus is linked to a media provider comprises:
loading the media type transfer program into the media provider when the portable media playback apparatus is linked to a media provider through an interface bus; and
residing the media type transfer program in the media provider.

3. The media type supporting method as claimed in claim 2, wherein the interface bus is a universal serial bus (USB).

4. The media type supporting method as claimed in claim 1, wherein the step of transferring the type of the specific medium to the type supported by the portable apparatus through the media type transfer program when the media provider receives an instruction which indicates the media provider to store a specific medium into the portable media playback apparatus, and the portable apparatus does not support the type of the specific medium comprises:
checking whether or not the specific medium conforms to the type supported by the portable media playback apparatus when a user issues an instruction to the media provider to replicate the specific medium to the portable media playback apparatus; and
transferring the specific medium type through the media type transfer program when the specific medium type is not the type supported by the portable media playback apparatus.

5. The media type supporting method as claimed in claim 4, wherein the media provider is a computer, and the media type transfer program transfers type in the operating system of the computer.

6. The media type supporting method as claimed in claim 1, wherein the portable media playback apparatus is a flash memory portable media playback apparatus.

7. The media type supporting method as claimed in claim 1, wherein the portable media playback apparatus is a mini hard disc portable media playback apparatus.

8. A media type supporting system, comprising:
a portable media playback apparatus, comprising a media type decoding engine and a media type transfer program;
a media provider;
executing the media type transfer program when the portable media playback apparatus is linked to a media provider; and
transferring the type of the specific medium to the type supported by the portable apparatus through the media type transfer program when the media provider receives an instruction which indicates the media provider to store a specific medium into the portable media playback apparatus, and the portable apparatus does not support the type of the specific medium.

9. The media type supporting system as claimed in claim 8, wherein the step of executing the media type transfer program when the portable media playback apparatus is linked to a media provider comprises:
loading the media type transfer program into the media provider when the portable media playback apparatus is linked to a media provider through an interface bus; and
residing the media type transfer program in the media provider.

10. The media type supporting system as claimed in claim 9, wherein the interface bus is a USB.

11. The media type supporting system as claimed in claim 8, wherein the step of transferring the type of the specific medium to the type supported by the portable apparatus through the media type transfer program when the media provider receives an instruction which indicates the media provider to store a specific medium into the portable media playback apparatus, and the portable apparatus does not support the type of the specific medium comprises:
checking whether the specific medium conforms to the type supported by the portable media playback apparatus when a user issues an instruction to the media provider to replicate the specific medium to the portable media playback apparatus; and
transferring the specific medium type through the media type transfer program when the specific medium type is not the type supported by the portable media playback apparatus.

12. The media type supporting method as claimed in claim 11, wherein the media provider is a computer, and the media type transfer program transfers type in the operating system of the computer.

13. The media type supporting system as claimed in claim 8, wherein the portable media playback apparatus is a flash memory portable media playback apparatus.

14. The media type supporting system as claimed in claim 8, wherein the portable media playback apparatus is a mini hard disc portable media playback apparatus.
